(19) United States
(12) Patent Application Publication
(10) Pub. No.: US 2021/0261202 A1
(43) Pub. Date: Aug. 26, 2021

(54) VEHICLE LOWER PART STRUCTURE

(71) Applicant: TOYOTA JIDOSHA KABUSHIKI KAISHA, Aichi-ken (JP)

(72) Inventors: Mutsumi KAWASHIMA, Nisshin-shi (JP); Ayaka KAGAMI, Inazawa-shi (JP); Yasuhide MATSUO, Toyota-shi (JP)

(21) Appl. No.: 17/105,637

(22) Filed: Nov. 27, 2020

(30) Foreign Application Priority Data
Feb. 20, 2020 (JP) 2020-027472

(51) Int. Cl. B62D 25/20; B60K 1/04; B60K 11/02

(52) U.S. Cl. CPC B62D 25/20; B60K 2001/0438; B60K 11/02; B60K 1/04

(57) ABSTRACT

In a vehicle lower part structure, a flow path for coolant is constituted by a tray bottom portion of a tray on which a battery is installed and second recesses of a plate. A flat plate portion of a protector is disposed on the lower side of the plate in a vehicle up-down direction, and the flat plate portion is connected to bottom portions of first recesses of the plate with bolts. The first recesses have a larger depth than the second recesses and the bottoms of the first recesses are located lower than those of the second recesses in the vehicle up-down direction. Thus, the flat plate portion of the protector is separated downward from the bottoms of the first recesses in the vehicle up-down direction.

### CROSS-REFERENCE TO RELATED APPLICATION

This application claims priority to Japanese Patent Application No. 2020-027472 filed on Feb. 20, 2020, incorporated herein by reference in its entirety.

### BACKGROUND

### 1. Technical Field

The disclosure relates to a vehicle lower part structure in which a battery case is disposed in a lower part of a vehicle.

### 2. Description of Related Art

For example, in the configuration disclosed in Japanese Unexamined Patent Application Publication No. 2015-224027 (JP 2015-224027 A), the cross-sectional shape of the cooling duct is, for example, a generally U-shape that opens to the upper side of the vehicle. A support plate constituting the base body is disposed on the opening side of the cooling duct, and the opening side of the cooling duct is closed by the support plate. Further, the base body is provided with an armor plate (protector) having a substantially flat plate shape. In the first embodiment of JP 2015-224027 A, the cooling duct is disposed inside the groove provided in the armor plate, and in the second embodiment of JP 2015-224027 A, the cooling duct is disposed on the armor plate. In such a configuration, the cooling duct is in contact with at least the upper surface of the armor plate. Thus, for example, when a load from the lower side of the armor plate in the vehicle up-down direction is input to the armor plate, the load is directly transmitted from the armor plate to the cooling duct, which may deform the cooling duct together with the armor plate.

### SUMMARY

In view of the above facts, an object of the disclosure is to obtain a vehicle lower part structure capable of suppressing the load from the lower side of the vehicle from being transmitted to the refrigerant passage.

A vehicle lower part structure according to claim 1 includes: a case that is provided on a lower side of a vehicle, in which a battery is installed on an installation portion, a flow path for a refrigerant is provided on a lower side of the installation portion in a vehicle up-down direction, and heat is exchangeable between the battery and the refrigerant; and a protector provided so as to be separated downward from the flow path in the vehicle up-down direction.

With the vehicle lower part structure according to claim 1, the battery is installed on the installation portion of the case. The flow path for the refrigerant is provided on the lower side of the installation portion in the vehicle up-down direction. When heat is exchanged between the refrigerant flowing through the flow path and the battery on the installation portion of the case, the battery is cooled.

The vehicle lower part structure also includes the protector. The protector is provided so as to be separated downward from the flow path for the refrigerant in the vehicle up-down direction. Thus, even when a load from the lower side of the vehicle is input to the protector, it is possible to suppress the load from being transmitted from the protector to the flow path for the refrigerant.

According to a vehicle lower part structure of claim 2, in the vehicle lower part structure according to claim 1, the flow path is constituted by a flow path constituent member that is provided on the lower side of the installation portion in the vehicle up-down direction and joined to the installation portion and that takes a closed cross-sectional shape together with the installation portion, and the installation portion.

According to the vehicle lower part structure of claim 2, the flow path constituent member is provided on the lower side of the installation portion of the case in the vehicle up-down direction. The flow path constituent member is joined to the installation portion of the case to take a closed cross-sectional shape together with the installation portion, thereby constituting the flow path for the refrigerant. Thus, the installation portion of the case constitutes the flow path for the refrigerant, so it is possible to reduce members interposed between the battery on the installation portion and the refrigerant.

According to a vehicle lower part structure of claim 3, in the vehicle lower part structure according to claim 1 or 2, the protector is connected to the case on a side of the flow path in a direction intersecting a vehicle front-rear direction.

According to the vehicle lower portion structure of claim 3, the protector is connected to the case on a side of the flow path in the direction intersecting the vehicle front-rear direction. Therefore, the load input to the protector from the lower side of the vehicle is transmitted to the case via a connecting portion between the protector and the case while bypassing the flow path for the refrigerant.

According to a vehicle lower part structure of claim 4, the vehicle lower part structure according to any one of claims 1 to 3 further includes a reinforcing portion that is provided on the installation portion and that reinforces the case, wherein the protector is connected to the reinforcing portion.

According to the vehicle lower part structure of claim 4, the reinforcing portion is provided on the installation portion of the case, and the case is reinforced by the reinforcing portion. Here, in the vehicle lower part structure, the protector is connected to the reinforcing portion. Therefore, the load input to the protector from the lower side of the vehicle is transmitted from the protector to the reinforcing portion.

As described above, in the vehicle lower part structure according to claim 1, it is possible to suppress the load from being transmitted to the flow path for the refrigerant.

In the vehicle lower part structure according to claim 2, components between the battery on the installation portion and the refrigerant can be reduced, so heat can be efficiently exchanged between the battery and the refrigerant.

In the vehicle lower part structure according to claim 3, the load input to the protector from the lower side of the vehicle is transmitted from the protector to the case, so that the load is dispersed to the case. Therefore, it is possible to effectively suppress the load from being transmitted to the flow path for the refrigerant.

In the vehicle lower part structure according to claim 4, the load input to the protector from the lower side of the vehicle is transmitted from the protector to the reinforcing portion, so that the reinforcing portion can support the load and the load can be dispersed to the reinforcing portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view taken along line 1-1 of FIG. 2, showing a configuration of a part of a vehicle lower part structure on a front side in a vehicle front-rear direction according to an embodiment of the disclosure; and

FIG. 2 is an exploded perspective view showing the vehicle lower part structure according to the embodiment of the disclosure.

### DETAILED DESCRIPTION OF EMBODIMENTS

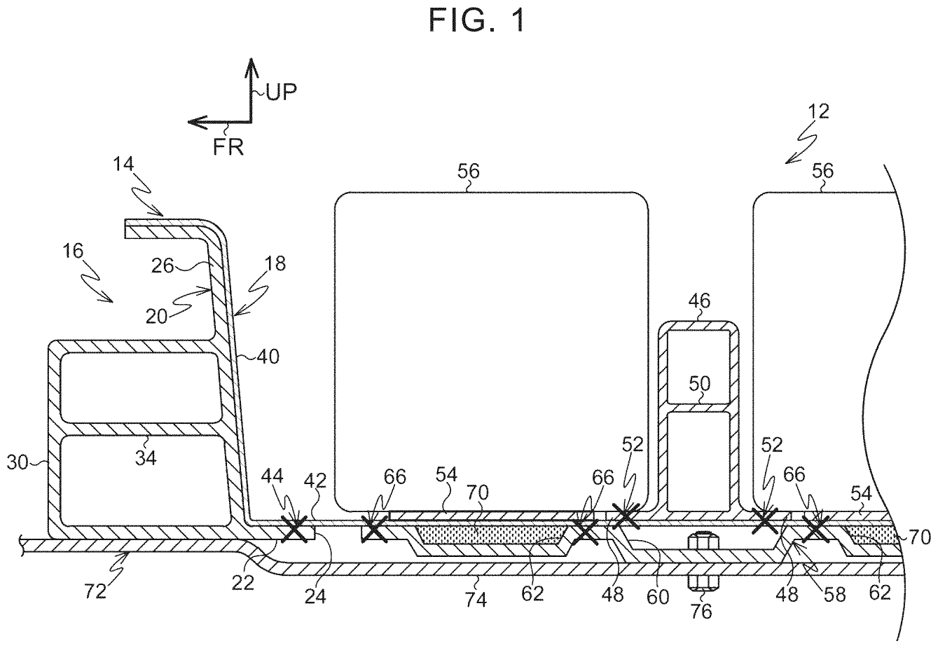

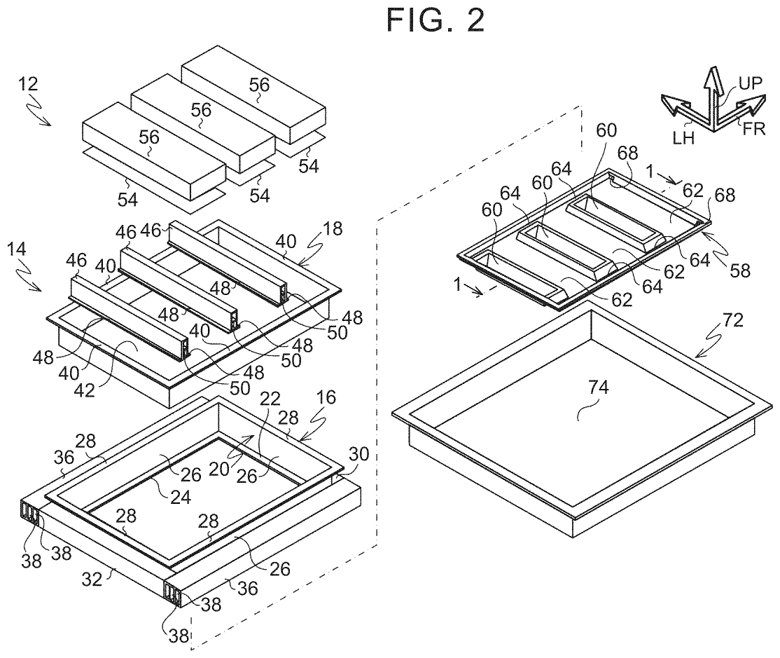

A vehicle lower part structure according to an embodiment of the disclosure will be described with reference to FIGS. 1 and 2. It should be noted that an arrow FR that is appropriately shown in FIGS. 1 and 2 indicates the front side of a vehicle (vehicle front side) to which the vehicle lower part substructure is applied. An arrow UP indicates the vehicle upper side, and an arrow LH indicates the left side of the vehicle (left side in the vehicle width direction).

### Structure of Present Embodiment

As shown in FIGS. 1 and 2, the vehicle lower part structure according to the present embodiment includes a battery unit 12. The battery unit 12 includes a case 14. The case 14 includes a frame 16 and a tray 18. The frame 16 as a whole is made of metal such as aluminum or an alloy containing aluminum. The frame 16 includes a frame body 20, and the frame body 20 includes a frame bottom portion 22. The frame bottom portion 22 has a rectangular flat plate shape in a plan view as viewed in the vehicle up-down direction. Further, a hole 24 is provided at the center of the frame bottom portion 22. The hole 24 is rectangular in a plan view. Thus, the frame bottom portion 22 has a rectangular frame shape in a plan view.

Frame vertical walls 26 are erected from the outer peripheral portion of the frame bottom portion 22 substantially toward the upper side of the vehicle. Further, a frame flange 28 extends toward the front side of the vehicle from an upper end, in the vehicle up-down direction, of the frame vertical wall 26 on the front side in the vehicle front-rear direction. A frame flange 28 extends toward the rear side of the vehicle from an upper end, in the vehicle up-down direction, of the frame vertical wall 26 on the rear side in the vehicle front-rear direction. In addition, a frame flange 28 extends toward the left side of the vehicle from an upper end, in the vehicle up-down direction, of the frame vertical wall 26 on the left side in the vehicle width direction, and a frame flange 28 extends toward the right side of the vehicle from an upper end, in the vehicle up-down direction, of the frame vertical wall 26 on the right side in the vehicle width direction.

The frame 16 also includes a front frame 30 and a rear frame 32. The front frame 30 is also provided on the lower side, in the vehicle up-down direction, of the frame flange 28 on the front side in the vehicle front-rear direction, and the rear frame 32 is also provided on the lower side, in the vehicle up-down direction, of the frame flange 28 on the rear side in the vehicle front-rear direction. The longitudinal direction of the front frame 30 and the rear frame 32 extends generally along the vehicle width direction. These frame flanges 28 are directly or indirectly connected to a floor panel constituting the vehicle body of the vehicle, from the lower side of the floor panel in the vehicle up-down direction, for example. Thus, the case 14 is attached to the vehicle body.

As shown in FIG. 1, the cross-sectional shape of each of the front frame 30 and the rear frame 32 taken in a direction orthogonal to the vehicle width direction is hollow. The front frame 30 takes a closed cross-sectional shape together with the frame vertical wall 26 on the front side in the vehicle front-rear direction, and the rear frame 32 takes a closed cross-sectional shape together with the frame vertical wall 26 on the rear side in the vehicle front-rear direction. An inner wall 34 is provided inside each of the front frame 30 and the rear frame 32, and a space inside each of the front frame 30 and the rear frame 32 is divided into two in the vehicle up-down direction by the inner wall 34 (the inner wall 34 of the rear frame 32 is not shown).

Further, as shown in FIG. 2, the frame 16 includes a pair of side frames 36. One side frame 36 is also provided on the lower side, in the vehicle up-down direction, of the frame flange 28 on the left side in the vehicle width direction, and the other side frame 36 is also provided on the lower side, in the vehicle up-down direction, of the frame flange 28 on the right side in the vehicle width direction. The longitudinal direction of the side frames 36 extends generally along the vehicle front-rear direction.

The cross-sectional shape of each of the side frames 36 taken in a direction orthogonal to the vehicle front-rear direction is hollow. The one side frame 36 takes a closed cross-sectional shape together with the frame vertical wall 26 on the left side in the vehicle width direction, and the other side frame 36 takes a closed cross-sectional shape together with the frame vertical wall 26 on the right side in the vehicle width direction. A plurality of inner walls 38 are provided inside each of the side frames 36, and the space inside each of the side frames 36 is divided into three in the vehicle width direction by the inner walls 38.

On the other hand, the tray 18 that constitutes the case 14 together with the frame 16 is made of metal as a whole, such as aluminum or an alloy containing aluminum. As shown in FIG. 2, the tray 18 as a whole has a box shape opening toward the upper side of the vehicle. Tray flanges 40 extend outward of the tray 18 from an upper end of the tray 18, in a direction orthogonal to the vehicle up-down direction. As shown in FIG. 1, the tray 18 is disposed inside the frame body 20 of the frame 16. With the tray 18 disposed inside the frame body 20, a tray bottom portion 42 of the tray 18 that serves as an installation portion is in contact with the frame bottom portion 22 of the frame body 20, and the tray bottom portion 42 and the frame bottom portion 22 are integrally welded at a welding portion 44.

Inside the tray 18, a plurality of cross reinforcements 46 are provided as reinforcing portions. The longitudinal direction of the cross reinforcements 46 extends along the vehicle width direction. The cross-sectional shape of the cross-reinforcements 46 cut in the direction orthogonal to the longitudinal direction of the cross-reinforcements 46 is rectangular, and the cross reinforcements 46 each have a hollow shape extending in the longitudinal direction. An inner wall 50 is provided inside each of the cross reinforcements 46, and the space inside each of the cross reinforcements 46 is divided into two in the vehicle up-down direction by the inner wall 50.

A cross flange 48 extends toward the front side of the vehicle from a front end, in the vehicle front-rear direction, of the cross reinforcement 46 at a lower end in the vehicle up-down direction, and a cross flange 48 extends toward the rear side of the vehicle from a rear end, in the vehicle front-rear direction, of the cross reinforcement 46 at a lower end in the vehicle up-down direction. The cross flanges 48 are in contact with the tray bottom portion 42 of the tray 18, and the cross flanges 48 and the tray bottom portion 42 are integrally welded at welding portions 52.

A heat conductive sheet 54 serving as a heat conductive member is provided between a vertical wall of the tray 18 on the front side in the vehicle front-rear direction and the cross reinforcement 46, between the cross reinforcements 46 adjacent to each other in the vehicle front-rear direction, and between a vertical wall of the tray 18 on the rear side in the vehicle front-rear direction and the cross reinforcement 46. The heat conductive sheet 54 is a sheet having a rectangular shape in a plan view and made of a member having a higher heat conductivity than the frame 16 and the tray 18, for example. The heat conductive sheets 54 are placed on the tray bottom portion 42 while being in contact with the tray bottom portion 42 of the tray 18.

Batteries 56 are placed on the heat conductive sheets 54. The batteries 56 are, for example, secondary batteries such as lithium ion secondary batteries. The batteries 56 are electrically connected to a motor via a control device, and electric power from the batteries 56 is supplied to the motor by the control device to drive the motor. When the driving wheels of the vehicle are thus rotated by the driving force output from the motor, the vehicle runs.

A plate 58 serving as a flow path constituent member is provided on the lower side of the tray 18 in the vehicle up-down direction. For example, the plate 58 is formed by press-forming a plate material made of metal such as aluminum or an alloy containing aluminum.

The plate 58 has a plurality of first recesses 60. The first recesses 60 each have a generally U-shape opening toward the upper side of the vehicle, and the longitudinal direction of each first recess 60 extends along the vehicle width direction. The first recesses 60 are provided at predetermined intervals in the vehicle front-rear direction, and the cross reinforcement 46 is disposed on the tray bottom portion 42 of the tray 18 on the upper side of each first recess 60 in the vehicle up-down direction.

Second recesses 62 are provided on the front side and the rear side of the first recesses 60 in the vehicle front-rear direction. The second recesses 62 each have a generally U-shape opening toward the upper side of the vehicle, and the longitudinal direction of each second recess 62 extends along the vehicle width direction. The heat conductive sheet 54 and the battery 56 are disposed on the tray bottom portion 42 of the tray 18 on the upper side of each first recess 60 in the vehicle up-down direction.

In the plate 58, portions of the upper ends, in the vehicle up-down direction, of each second recess 62 on both sides in the vehicle front-rear direction are in contact with the tray bottom portion 42 of the tray 18 from the lower side in the vehicle up-down direction, and are integrally welded to the tray bottom portion 42 at welding portions 66. As a result, the cross section obtained by cutting the second recess 62 and the tray bottom portion 42 along a direction orthogonal to the vehicle width direction has a closed rectangular shape.

Further, third recesses 64 are provided on both sides of each first recess 60 in the vehicle width direction. The third recesses 64 each have a generally U-shape opening toward the upper side of the vehicle. Both ends of each third recess 64 in the vehicle front-rear direction are connected to the second recesses 62, and inside the second recesses 62 and the inside of the third recesses 64 communicate with each other.

Further, a vertical wall on the front side in the vehicle front-rear direction that constitutes the foremost second recess 62 in the vehicle front-rear direction has a pair of holes 68. One hole 68 is provided at a left end, in the vehicle width direction, of the vertical wall of the second recess 62 on the front side in the vehicle front-rear direction, and the other hole 68 is provided at a right end, in the vehicle width direction, of the vertical wall of the second recess 62 on the front side in the vehicle front-rear direction. The holes 68 pass through the vertical wall of the second recess 62 on the front side in the vehicle front-rear direction. The holes 68 are connected to a radiator (heat exchanger) mounted on the vehicle, with a pipe or the like. Coolant 70 (see FIG. 1) serving as a refrigerant supplied from the radiator is supplied to one hole 68 through a pipe or the like.

The coolant 70 is made of, for example, a liquid such as water or ethylene glycol. The coolant 70 that has passed through the one hole 68 passes through the inside of the second recesses 62 and the inside of the third recesses 64. When the coolant 70 flows inside the second recesses 62, heat is exchanged between the coolant 70 and the batteries 56 to cool the batteries 56 and warm the coolant 70. The coolant 70 thus warmed flows out from the other hole 68. The coolant 70 flowing out from the other hole 68 flows to the radiator via a pipe or the like. In the radiator, for example, heat is exchanged between the traveling air that passes through the radiator when the vehicle is traveling and the coolant 70 that flows inside the radiator, whereby the coolant 70 is cooled.

A protector 72 is provided on the lower side of the above-described configuration in the vehicle up-down direction. The protector 72 is made of metal such as aluminum or iron, or an alloy containing such metal, and is connected to and supported by the floor panel or the like of the vehicle at its outer peripheral portion. The protector 72 includes a flat plate portion 74. The flat plate portion 74 has a generally rectangular flat plate shape in a plan view, and is disposed on the lower side of the plate 58 in the vehicle up-down direction. A surface, on the upper side in the vehicle up-down direction, of the flat plate portion 74 of the protector 72 is in contact with surfaces, on the lower side in the vehicle up-down direction, of the bottom portions of the first recesses 60 of the plate 58. The surface of the flat plate portion 74 on the upper side in the vehicle up-down direction and the bottom portions of the first recesses 60 of the plate 58 are integrally connected to each other with bolts 76 serving as fastening members.

Here, the first recesses 60 of the plate 58 have a larger depth than the second recesses 62 and the third recesses 64, and therefore, the bottom portions of the first recesses 60 are located lower than the bottom portions of the second recesses 62 and the bottom portions of the third recesses 64 in the vehicle up-down direction. Thus, since the flat plate-shaped flat plate portion 74 is in contact with the bottom portions of the first recesses 60, the flat plate portion 74 is separated downward from the bottom portions of the second recesses 62 and the bottom portions of the third recesses 64 in the vehicle up-down direction.

### Operations and Effects of Present Embodiment

In the present embodiment, the heat conductive sheets 54 are placed on the tray bottom portion 42 of the tray 18 of the case 14, and the batteries 56 are placed on the heat conductive sheets 54. The batteries 56 may generate heat when being charged, for example. Here, below the batteries 56 in the vehicle up-down direction, the coolant 70 flows inside the second recesses 62 of the plate 58. When the temperature of the coolant 70 is lower than the temperature of the batteries 56, heat is exchanged between the coolant 70 and the batteries 56. As a result, the batteries 56 are cooled and the temperature rise of the batteries 56 can be suppressed.

On the other hand, when the vehicle is traveling, the lower part of the vehicle may come into contact with a road surface due to the unevenness of the road surface and the like to receive a load from the lower side of the vehicle. Here, the protector 72 is provided on the lower side of the case 14 in the vehicle up-down direction. Therefore, the case 14 can be suppressed from directly contacting the road surface, and the load from the road surface can be suppressed from being directly input to the case 14. Further, the flat plate portion 74 of the protector 72 is provided on the lower side of the plate 58 in the vehicle up-down direction. Therefore, it is possible to suppress the load from the road surface from being directly input to the plate 58, particularly to the second recesses 62 and the third recesses 64.

The second recesses 62 and the third recesses 64 of the plate 58, together with the tray bottom portion 42 of the tray 18, constitute a flow path for the coolant 70. Thus, the load from the road surface can be suppressed from being directly input to the second recesses 62 and the third recesses 64, thereby suppressing the second recesses 62 or the third recesses 64 from being deformed by the load from the road surface. As a result, it is possible to suppress stagnation of the coolant 70 due to the deformation of the second recesses 62 or the third recesses 64, or leakage of the coolant 70 to the outside of the second recesses 62 or the third recesses 64.

Further, the flat plate portion 74 of the protector 72 is separated downward from the bottom portions of the second recesses 62 and the bottom portions of the third recesses 64 in the vehicle up-down direction. Thus, it is possible to suppress the load from the road surface input to the flat plate portion 74 of the protector 72 from being transmitted from the flat plate portion 74 to the bottom portions of the second recesses 62 or the bottom portions of the third recesses 64. Accordingly, it is possible to effectively suppress the second recesses 62 or the third recesses 64 from being deformed by the load from the road surface. As a result, it is possible to effectively suppress stagnation of the coolant 70 due to the deformation of the second recesses 62 or the third recesses 64, or leakage of the coolant 70 to the outside of the second recesses 62 or the third recesses 64.

The flat plate portion 74 of the protector 72 is connected to the bottom portions of the first recesses 60 of the plate 58 with the bolts 76. Further, in the plate 58, the portions of the upper ends, in the vehicle up-down direction, of each second recess 62 on both sides in the vehicle front-rear direction are integrally welded to the tray bottom portion 42 of the tray 18 at the welding portions 66. Thus, the load from the road surface input to the flat plate portion 74 of the protector 72 is transmitted to the bottom portions of the first recesses 60 of the plate 58 and further transmitted to the tray bottom portion 42 of the tray 18. Thereby, the load from the road surface can be dispersed to the tray 18.

Further, the tray bottom portion 42 of the tray 18 is integrally welded to the frame bottom portion 22 of the frame 16 at the welding portion 44. Thus, the load from the road surface can be dispersed to the frame 16 having a rigidity higher than that of the tray 18, the plate 58, etc. and the load from the road surface can be supported by the frame 16.

The tray bottom portion 42 of the tray 18 is integrally welded to the cross reinforcements 46 at the welding portions 52. Thus, the load from the road surface can be dispersed to the high-strength cross reinforcements 46 provided to reinforce the case 14, and the load from the road surface can be supported by the cross reinforcements 46.

The protector 72 is connected to the plate 58 by the bolts 76. Therefore, it is not necessary to provide holes in the tray 18 for passing and disposing the bolts 76 and the like. This can increase the watertightness of the tray 18 on the tray bottom portion 42 side.

In the present embodiment, the second recesses 62 and the third recesses 64 of the plate 58 and the tray bottom portion 42 of the tray 18 constitute the flow path for the coolant 70. In such a configuration, the tray bottom portion 42 is directly cooled by the coolant 70. Therefore, as compared with a configuration in which a tubular flow path for the coolant 70 is disposed on the lower side of the tray bottom portion 42 of the tray 18 in the vehicle up-down direction to indirectly cool the tray bottom portion 42 with the coolant via the flow path, the bottom portion 42 can be efficiently cooled. Thereby, the batteries 56 can be cooled efficiently.

In the configuration in which the tubular flow path for the coolant 70 is disposed on the lower side of the tray bottom portion 42 of the tray 18 in the vehicle up-down direction, a heat conductive member is provided between the flow path and the tray bottom portion 42 to improve the cooling efficiency of the tray bottom portion 42. In the present embodiment, however, the coolant 70 directly cools the tray bottom portion 42, so a heat conductive member is not necessary and the number of parts can be reduced.

In the present embodiment, the tray bottom portion 42 of the tray 18 and the second recesses 62 of the plate 58 constitute the flow path for the coolant 70. However, a configuration may be adopted in which a tubular flow path for the coolant 70 is provided separately from the tray 18 and the tray bottom portion 42 is indirectly cooled by the coolant 70 via the tubular flow path.

Further, in the present embodiment, the plate 58 is integrally connected to the frame bottom portion 22 of the frame 16 and the cross reinforcements 46 via the tray bottom portion 42 of the tray 18. However, the plate 58 need not be connected to the frame bottom portion 22 and need not be connected to the cross reinforcements 46.

In the present embodiment, the refrigerant is the liquid coolant 70. However, the refrigerant may be a gas and is not limited to a specific form of the refrigerant.

Further, in the present embodiment, the case 14 has a box shape opening toward the upper side of the vehicle. However, the case 14 in the present embodiment may be used as a lower case, and an upper case may be separately provided to cover and seal the lower case from above in the vehicle up-down direction.

What is claimed is:

1. A vehicle lower part structure comprising:
a case that is provided on a lower side of a vehicle, in which a battery is installed on an installation portion, a flow path for a refrigerant is provided on a lower side of the installation portion in a vehicle up-down direction, and heat is exchangeable between the battery and the refrigerant; and
a protector provided so as to be separated downward from the flow path in the vehicle up-down direction.

2. The vehicle lower part structure according to claim 1, wherein the flow path is constituted by a flow path constituent member that is provided on the lower side of the installation portion in the vehicle up-down direction and joined to the installation portion and that takes a closed cross-sectional shape together with the installation portion, and the installation portion.

3. The vehicle lower part structure according to claim 1, wherein the protector is connected to the case on a side of the flow path in a direction intersecting a vehicle front-rear direction.

4. The vehicle lower part structure according to claim 1, further comprising a reinforcing portion that is provided on the installation portion and that reinforces the case, wherein the protector is connected to the reinforcing portion.
